(19) United States
(12) Patent Application Publication
(10) Pub. No.: US 2008/0097815 A1
(43) Pub. Date: Apr. 24, 2008

(54) Methods for employing temporary time zones and predictive locations and systems thereof

(75) Inventors: David Koretz, Pittsford, NY (US); Robert Chamberlin, Webster, NY (US); James Simpson, Rochester, NY (US); Stephen Wong, Rochester, NY (US)

Correspondence Address: NIXON PEABODY LLP - PATENT GROUP, 1100 CLINTON SQUARE, ROCHESTER, NY, 14604, US

(73) Assignee: BlueTie, Inc., Pittsford, NY (US)

(21) Appl. No.: 11/584,490

(22) Filed: Oct. 23, 2006

(51) Int. Cl. G06F 15/02

(52) U.S. Cl. 705/9

(57) ABSTRACT

A method, system, and computer readable medium for enabling a user within an application to select a time zone for a temporary period of time include selecting a temporary time zone having a start time and an end time, and changing a time of events that fall within the temporary time zone.

### FIELD OF THE INVENTION

This invention generally relates to time zones and scheduling within calendar software and methods thereof and, more particularly, to automatically creating a temporary time zone that simplifies scheduling for those users that travel across time zones and methods thereof.

### BACKGROUND

Users that frequently travel can be constantly challenged with booking events, such as meetings, and the like. Current stand-alone desktop software applications that have a calendar feature typically are only designed to operate within a single time zone. Accordingly, such applications have extremely limited time zone support.

Client-server-based systems and Web-based systems improve upon desktop systems by enabling users in multiple time zones to schedule meetings with one another that account for each user's time zone. However, none of the available systems account for individual users who find themselves in multiple time zones, for example, due to travel, and the like. For example, such systems do not let a user be in a given time zone for a given period of time (e.g., during a week long business trip, etc.), so that when users on such a system schedule events with each other the system is intelligent enough to account for the traveler's temporary time zone, and not just the meeting scheduler's time zone or the invitee's default time zone. This major limitation prevents users from being able to accurately schedule meetings among those who travel. As a result of the inability to account for the traveler's temporary time zone the meeting will either appear at the wrong time for the traveler or at the wrong time for all other attendees. The meeting is never correct in all attendees' calendars.

A recent system, such as described U.S. Pat. No. 6,647,370, does track different types of times, including “local” time, “home” time, and “remote” time of a user, and shows events and appointments in the user's own “local” time (or other user-selected type of time), regardless of where the user is presently located. However, although such systems may overcome the challenges of identifying time zones based on GPS, user input, other means, and the like, such systems, for example, do nothing to simplify the scheduling of events by multiple parties. Accordingly, although it may be easy to adjust the time of a personal event based on the detection of a new time zone, it is more challenging if there are multiple attendees to such an event. This is even more complicated with networked-based systems, such as Web-based calendars, and the like, which may have multiple people in different locations scheduling meetings with one another. Accordingly, such systems do not account for such challenges, as such systems typically link a time zone to a particular event. In addition, such systems do not account for conference calls, Web conferencing, Wiki's, shared workspaces, and the like, for example where user's work across multiple time zones simultaneously.

In addition, current systems do not assist the user in automatically selecting the most probable location for an event, such as a meeting, and the like, which increases the time it takes to schedule such a meeting, and makes, for example, the generation of maps, driving directions, and the like, a difficult process.

### SUMMARY

A method for enabling a user within an application to select a time zone for a temporary period of time, in accordance with exemplary embodiments of the present invention, includes selecting a temporary time zone having a start time and an end time, and changing a time of events that fall within the temporary time zone.

A computer readable medium having stored thereon programmed instructions for enabling a user within an application to select a time zone for a temporary period of time, in accordance with exemplary embodiments of the present invention, includes selecting a temporary time zone having a start time and an end time, and changing a time of events that fall within the temporary time zone.

A system that enables a user within an application to select a time zone for a temporary period of time, in accordance with exemplary embodiments of the present invention, includes means for selecting a temporary time zone having a start time and an end time, and means for changing a time of events that fall within the temporary time zone.

The present invention provides a number of advantages, including providing an effective method for users of a Web-based or client-server calendar software application to schedule a temporary time zone that simplifies scheduling for a period of time. The present invention also provides the user with a simple way to handle scheduling for longer periods of time, such as with a business trip, and the like. Advantageously, this can be accomplished automatically, for example, by selecting a given meeting attendee's home address, meeting attendee's work address, hotel address, flight arrival airport, and the like. The present invention enables users to easily schedule meetings while temporarily in a time zone other than their home time zone, and have the meeting accurately appear in all calendars. The present invention also is beneficial for the scheduling of reservations, reminders, notifications of regional events, and other location-sensitive data that may be input into a calendar. Further, the present invention reduces the amount of time it takes to schedule meetings and temporary time zones, by detecting, for example, a flight, hotel, or other event that takes place in a different time zone and automatically creating the temporary time zone.

### BRIEF DESCRIPTION OF THE DRAWINGS

FIG. 1 is a block diagram of a system for employing temporary tine zones and predictive locations in accordance with exemplary embodiments of the present invention;

FIG. 2 is a flow chart of a temporary time zone creation process within an application in accordance with exemplary embodiments of the present invention; and

FIG. 3 is a flow chart of a temporary time zone interaction process within an application in accordance with exemplary embodiments of the present invention.

### DETAILED DESCRIPTION

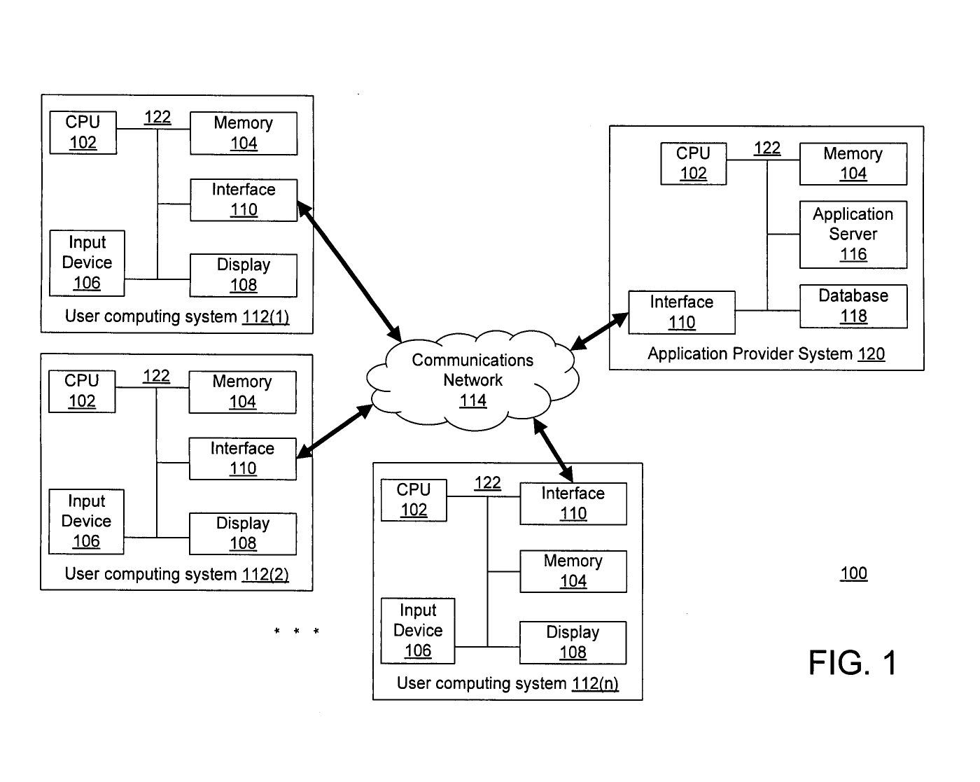

Referring now to the drawings, wherein like reference numerals designate identical or corresponding parts throughout the several views and more particularly to FIG. 1 thereof, there is illustrated a block diagram of an exemplary system 100 for employing temporary tine zones and predictive locations in accordance with embodiments of the present invention. In FIG. 1, the exemplary system 100 includes an application provider system 120, user computing systems 112(1), 112(2), . . . 112(n), and a communications network 114, although the exemplary system 100 can include other numbers and types of server systems, systems, devices, equipment, and/or components in other configurations. The exemplary embodiments provide a number of advantages over conventional systems, for example, including effective and automatic processes for users to establish a block of time, with a start time and end time, as a temporary time zone, within a calendar. With the exemplary embodiments, a user can create a defined time period where they will be in a different time zone, for example, which will let third parties schedule meetings with the user and visa versa and have the meetings appear correctly in both calendars simultaneously. The exemplary embodiments further enable users to see their calendars in local time zone at all times.

Referring more specifically to FIG. 1, the application provider system 120 provides, for example, a calendar application, and the like, via an application server 116 to the user computing systems 112(1), 112(2), . . . 112(n), where users can schedule temporary time zones, for example, for the convenience of viewing and scheduling activities in a calendar, and the like. The application provider system 120 includes a central processing unit (CPU) or processor 102, a memory 104, and an interface system 110, and which are coupled together by a bus or other link 122, although other numbers and types of each of the components and other configurations and locations for the components can be used.

The processor 102 in the application provider system 120 executes a program of stored instructions for one or more aspects of the exemplary embodiments as described herein. The memory 104 stores these programmed instructions for one or more aspects of the exemplary embodiments as described herein, although some or all of the programmed instructions could be stored and/or executed elsewhere. A variety of different types of memory storage devices, such as a random access memory (RAM), flash memory or a read only memory (ROM) in the system or a floppy disk, hard disk, CD ROM, DVD ROM, or other computer readable medium which is read from and/or written to by a magnetic, optical, or other reading and/or writing system that is coupled to the processor 102, can be used for the memory 104 in the application provider system 120. The interface system 110 in the application provider system 120 is used to operatively couple and communicate between the application provider system 120 and the one or more user computing systems 112(1), 112(2), . . . 112(n) via communications network 114, although other types and numbers of connections and other configurations and other types of communication networks can be employed. For example, in an exemplary embodiment, the communication network 114 can employ TCP/IP over Ethernet and industry-standard protocols, including SOAP, HTML, HTTPS, XML, LDAP, SNMP, WSDL, UDDI, and the like, although other types and numbers of communication networks, such as a direct connection, a local area network, a wide area network, modems and phone lines, e-mail, wireless communication technology, and the like, each having their own communications protocols, can be employed.

The application provider system 120 further includes a database 118, for example, for storing user data, application data, and the like, although other types and numbers of data storage devices can be employed, as will be appreciated by those skilled in the database art(s). For example, the database 118 can be a repository for all users' scheduled events and each user's relevant time zone for the event, and enables the coordination of meeting scheduling among multiple users.

Each of the user computing systems 112(1), 112(2), . . . 112(n) enable a user to utilize an application from the application provider system 120, although one or more of the user computing systems 112(1), 112(2), . . . 112(n) could utilize other applications and could provide a wide variety of other functions for the user. Each of the user computing systems 112(1), 112(2), . . . 112(n) includes a central processing unit (CPU) or processor 102, a memory 104, user input device 106, a display 108, and an interface system 110, and which are coupled together by a bus or other link 122, although one or more of the user computing systems 112(1), 112(2), . . . 112(n) can include other numbers and types of components and systems in other configurations. The processor 102 executes a program of stored instructions for one or more aspects of the exemplary embodiments as described and illustrated herein, for the creation of a temporary time zone within the calendar application, although the processor 102 could execute other types of programmed instructions.

The memory 104 stores these programmed instructions for one or more aspects of the exemplary embodiments as described herein, including an exemplary method for creating a temporary time zone, although some or all of the programmed instructions could be stored and/or executed elsewhere. A variety of different types of memory storage devices, such as a random access memory (RAM), flash memory or a read only memory (ROM) in the system or a floppy disk, hard disk, CD ROM, DVD ROM or other computer readable medium which is read from and/or written to by a magnetic, optical, or other reading and/or writing system that is coupled to one or more processors, can be used for the memory 104.

The user input device 106 is used to input selections, such as user appointment start times, appointment end times, time zone, appointment titles, other data, and the like, and to interact with the calendar application and scheduling features, although the user input device 106 could be used to input other types of data and interact with other elements. The user input device 106 can include a computer keyboard, a computer mouse, and the like, although other types and numbers of user input devices 106 can be employed.

The display 108 is used to show data and information to the user, such as the calendar application being utilized to create temporary time zones within the calendar application. The display 108 can include a computer display screen, such as a CRT or LCD screen, and the like, although other types and numbers of displays could be employed.

The interface system 110 is used to operatively couple and communicate between the user computing systems 112(1), 112(2), . . . 112(n) and application provider system 120 via the communications network 114, although other types and numbers of connections and other configurations and other types of communication systems can be employed.

Although exemplary embodiments of the application provider system 120, and the user computing systems 112(1), 112(2), . . . 112(n), are described and illustrated herein, each of the application provider system 120, the user computing systems 112(1), 112(2), . . . 112(n) of the exemplary embodiments can be implemented on any suitable computer system or computing device, and the like. It is to be understood that the devices and systems of the exemplary embodiments are for exemplary purposes, as many variations of the specific hardware and software used to implement the exemplary embodiments are possible, as will be appreciated by those skilled in the relevant art(s).

Furthermore, each of the systems of the exemplary embodiments may be conveniently implemented using one or more general purpose computer systems, microprocessors, digital signal processors, micro-controllers, and the like, programmed according to the teachings of the exemplary embodiments, as described and illustrated herein, and as will be appreciated by those skilled in the computer and software arts.

In addition, two or more computing systems or devices can be substituted for any one of the systems in any embodiment of the exemplary embodiments. Accordingly, principles and advantages of distributed processing, such as redundancy, replication, and the like, also can be implemented, as desired, to increase the robustness and performance of the devices and systems of the exemplary embodiments. The exemplary embodiments may also be implemented on computer system or systems that extend across any suitable network using any suitable interface mechanisms and communications technologies, including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The exemplary embodiments may also be embodied as a computer readable medium having instructions stored thereon for creating a temporary time zone in the calendar application as described herein, which when executed by a processor, cause the processor to carry out the steps necessary to implement the methods of the exemplary embodiments, as described and illustrated herein.

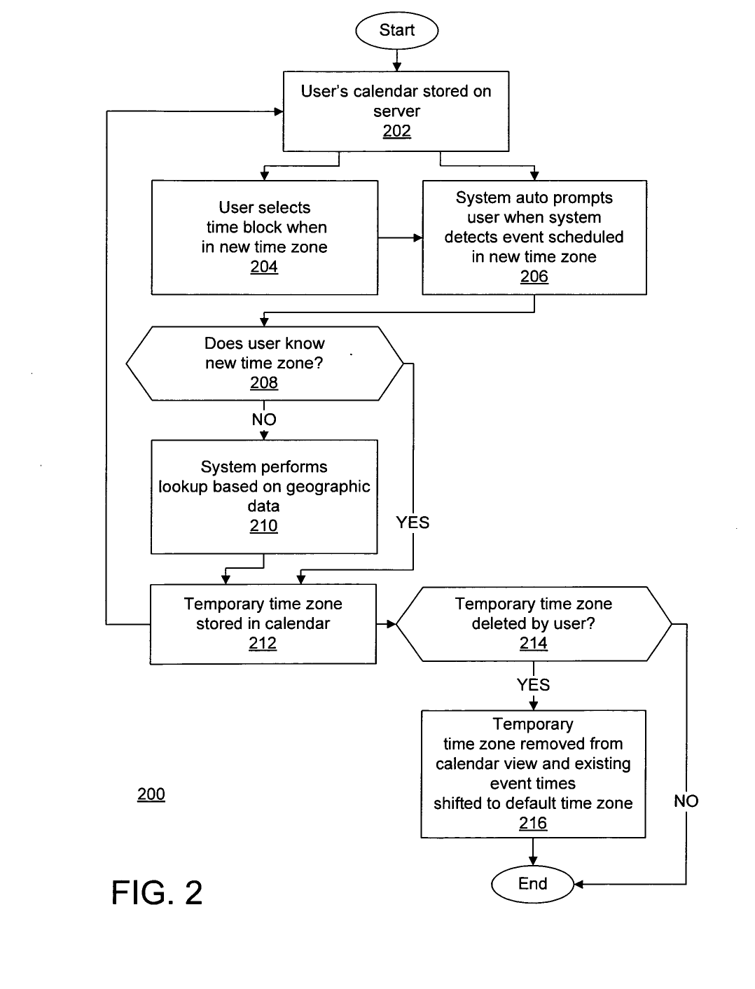

The operation of the exemplary system 100 in accordance with the exemplary embodiments will now be described with reference to FIGS. 1-2. In FIG. 2, in step 202, a date-based application, such a calendar application, and the like, is created for a user and stored on the application provider system 120.

In step 204, the user of the user computing systems 112(1), 112(2), . . . 112(n) selects via the application provider system 120 a time block, date block and the like, when the user is or will be geographically in a new time zone.

In step 206, the application provider system 120 automatically prompts the user of the user computing systems 112(1), 112(2), . . . 112(n) when the application server 116 detects events scheduled in the new time zone. If the user of computing systems 112(1), 112(2), . . . 112(n) does know which time zone is the correct entry, as determined in step 208, the process proceeds to step 212. If, however, the user of computing systems 112(1), 112(2), . . . 112(n) does not know which time zone is the correct entry, as determined in step 208, the user is taken to step 210. In step 210, the application provider system 120 queries the database 118 and performs a lookup, for example, based on geographic data, and the like, to determine the appropriate time zone for entry and the process then proceeds to step 212.

In step 212, a temporary time zone is set in the application provider system 120. If the user of the user computing system 112(1), 112(2), . . . 112(n) chooses not to delete the temporary time zone created, as determined in step 214, then the exemplary temporary time zone creation process 200 is completed. If, however, the user of the user computing system 112(1), 112(2), . . . 112(n) chooses to delete the temporary time zone created, as determined in step 214, then the user is taken to step 216. In step 216, the application provider system 120 deletes the temporary time zone from the calendar and shift events that were scheduled during the temporary time zone in the user computing system 112(1), 112(2), . . . 112(n) back to the default time zone, completing the exemplary temporary time zone creation process 200.

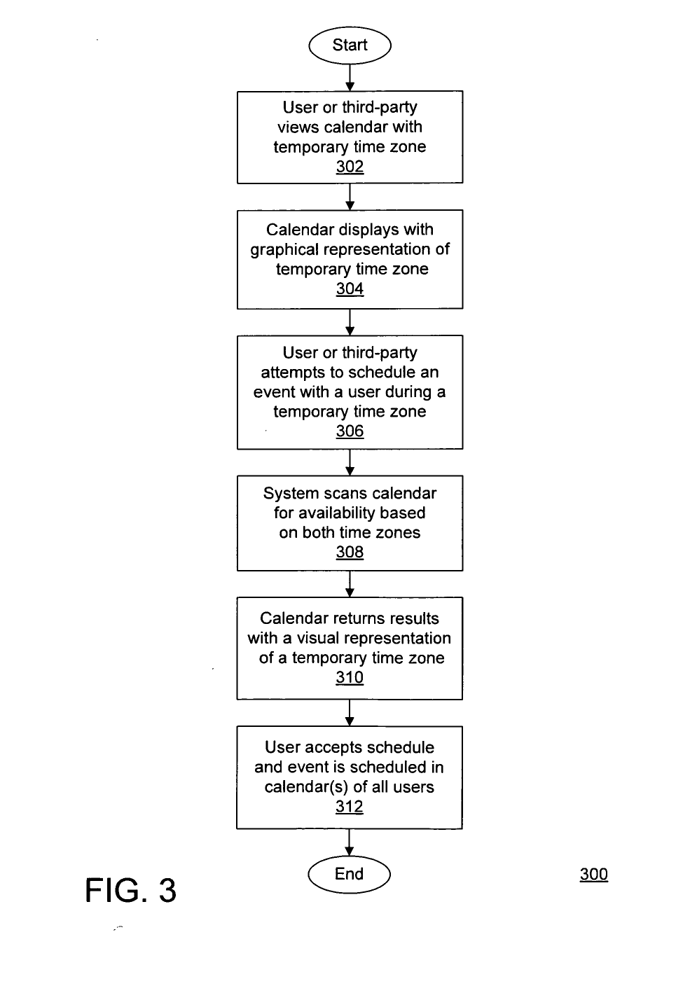

The operation of the exemplary system 100 in accordance with other exemplary embodiments will now be described with reference to FIGS. 1 and 3. In FIG. 3, in step 302, a user of the user computing system 112(1), 112(2), . . . 112(n) or a third party can access, for example, a date-based application, such as a calendar application, and the like, via the application provider system 120 to interact with a calendar, and the like, including a temporary time zone.

In step 304, the application provider system 120 displays the calendar application with a graphical representation of the temporary time zone on the user or third party display 108.

In step 306, the user of the user computing system 112(1), 112(2), . . . 112(n) or the third party can attempt to schedule an activity, such as an event, a meeting, and the like, with another user or with themselves during a temporary time zone timeframe in the calendar application of application provider system 120.

In step 308, the application provider system 120 scans for user availability based on both of the user or third party and the other user's active time zone during the scheduled activity time. Active time zones can be either a home time zone or the temporary time zone depending on the respective schedules of the user or third party or the other user at the time of the event.

In step 310, the application provider system 120 returns the results of step 308 on the user display 108 of the user computing system 112(1), 112(2), . . . 112(n) or the third party, for example, in the form a visual representation, and the like, of the users' schedule and third party's schedule overlaid onto a single calendar view to show availability based upon their respective active time zones and prior schedule commitments.

In step 312, the user of the user system 112(1), 112(2), . . . 112(n) or the third party can accept the calendar event for scheduling of the event in the calendar of all attendees, completing the exemplary temporary time zone interaction process 300.

As described herein, the present invention is versatile and can be added to a wide range of applications, including, but not limited to calendars, contacts, task management, instant messaging, time and attendance systems, Voice over Internet Protocol (VoIP), email, web conferencing, sales force automation, and CRM.

The present invention also solves the above-noted and other problems with conventional time zone management systems and methods. The present invention can be used for establishing a block of time with a start time and an end time as a temporary time zone (TTZ). Each user has their default time zone, and then can set a time zone for a given period of time on a temporary basis. Advantageously, the temporary time zone lets third parties schedule meetings with the user and have it appear correctly in both calendars simultaneously. The temporary time zone also enables users to see their calendar in a local time zone at all suitable times.

In addition, the present invention allows users to keep a single calendar with blocks of time that are given the temporary time zone, as may be established from time to time. The present invention also intelligently predicts a user's location at a given date/time, for example, based upon travel plans found in calendar, hotel addresses included in travel plans, addresses associated with meetings, and the like. The granularity of location prediction, for example, can be a function of granularity of data available in relevant applications, and users also can manually enter corrected current location data. Addresses and locations can be automatically associated with a calendar event, for example, as a function of the address data associated with invited attendees.

Advantageously, the present invention overcomes the limitations of existing cookie or server-side data storage-based mapping systems, which only remember the last few addresses a user entered. For example, the present invention intelligently decides what address a user is currently at or will be at, for example, based upon the date/time, context, and the like. The present invention thus can include various applications, including, for example, mapping from a current location to a next meeting location, yellow page searching results localized to predicted current location, weather forecasting localized to predicted current location, mapping of closest on-demand printing location based upon predicted current location, scheduling of package pick-up from an express package delivery company based upon predicted current location, and the like.

Accordingly, the present invention can include the temporary time zone feature, for example, which enables a user to select a block of time when they will be in another time zone, and their calendar will store the start time and end time they are in that time zone. Advantageously, the present invention then automatically can handle scheduling between a user who is traveling to a different time zone, and a user in the home time zone, and prevents the problem of scheduling between users where their home time zone is the same, forcing the scheduled time to be incorrect for one of the two users.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for enabling a user within an application to select a time zone for a temporary period of time, the method comprising:
selecting a temporary time zone having a start time and an end time; and
changing a time of events that fall within the temporary time zone.

2. The method of claim 1, further comprising identifying the temporary time zone with a visual identifier.

3. The method of claim 1, wherein the application comprises one of a Web-based application, a client-server application, and a calendar application.

4. The method of claim 2, wherein a scheduling system performs the identifying.

5. The method of claim 1, wherein a scheduling system performs the changing.

6. The method of claim 1, wherein the events include a meeting.

7. The method of claim 2, wherein the visual identifier includes a color.

8. The method of claim 3, further comprising creating the temporary time zone in the calendar application for booking meetings in multiple time zones within a single calendar.

9. The method of claim 2, wherein the visual identifier distinguishes the temporary time zone within a calendar application using a color.

10. The method of claim 6, further comprising predicting the temporary time zone based on a location field of the meeting including an address.

11. The method of claim 10, further comprising parsing the address into a standard format.

12. The method of claim 1, further comprising automatically offering the user an opportunity to create the temporary time zone.

13. The method of claim 12, further comprising automatically offering the user the opportunity to create the temporary time zone, when the user books a flight to a location in a different time zone.

14. The method of claim 6, further comprising prompting the user to select from a plurality of choices for destination of the meeting to establish the temporary time zone.

15. The method of claim 14, wherein the destination includes one of a home address of an invitee to the meeting, a work address of an invitee to the meeting, a hotel address of an invitee to the meeting, a destination airport of an invitee to the meeting, and an address of a nearest meeting.

16. The method of claim 1, wherein a time of an individual event appears differently in different people's calendar, based on the temporary time zone.

17. The method of claim 6, further comprising booking the meeting using a new event dialog box.

18. The method of claim 17, wherein the visual identifier includes at least one of text, and a graphic indicator.

19. A computer readable medium having stored thereon instructions for enabling a user within an application to select a time zone for a temporary period of time and comprising machine executable code which when executed by at least one processor, causes the processor to perform steps comprising:
selecting a temporary time zone having a start time and an end time; and
changing a time of events that fall within the temporary time zone.

20. The computer readable medium of claim 19, further comprising identifying the temporary time zone with a visual identifier.

21. The computer readable medium of claim 19, wherein the application comprises one of a Web-based application, a client-server application, and a calendar application.

22. The computer readable medium of claim 20, wherein a scheduling system performs the identifying.

23. The computer readable medium of claim 19, wherein a scheduling system performs the changing.

24. The computer readable medium of claim 19, wherein the events include a meeting.

25. The computer readable medium of claim 20, wherein the visual identifier includes a color.

26. The computer readable medium of claim 21, further comprising creating the temporary time zone in the calendar application for booking meetings in multiple time zones within a single calendar.

27. The computer readable medium of claim 20, wherein the visual identifier distinguishes the temporary time zone within a calendar application using a color.

28. The computer readable medium of claim 24, further comprising predicting the temporary time zone based on a location field of the meeting including an address.

29. The computer readable medium of claim 28, further comprising parsing the address into a standard format.

30. The computer readable medium of claim 19, further comprising automatically offering the user an opportunity to create the temporary time zone.

31. The computer readable medium of claim 30, further comprising automatically offering the user the opportunity to create the temporary time zone, when the user books a flight to a location in a different time zone.

32. The computer readable medium of claim 24, further comprising prompting the user to select from a plurality of choices for destination of the meeting to establish the temporary time zone.

33. The computer readable medium of claim 32, wherein the destination includes one of a home address of an invitee to the meeting, a work address of an invitee to the meeting, a hotel address of an invitee to the meeting, a destination airport of an invitee to the meeting, and an address of a nearest meeting.

34. The computer readable medium of claim 19, wherein a time of an individual event appears differently in different people's calendar, based on the temporary time zone.

35. The computer readable medium of claim 24, further comprising booking the meeting using a new event dialog box.

36. The computer readable medium of claim 35, wherein the visual identifier includes at least one of text, and a graphic indicator.

37. A system that enables a user within an application to select a time zone for a temporary period of time, the system comprising:
means for selecting a temporary time zone having a start time and an end time; and
means for changing a time of events that fall within the temporary time zone.

38. The system of claim 37, further comprising identifying the temporary time zone with a visual identifier.

39. The system of claim 37, wherein the application comprises one of a Web-based application, a client-server application, and a calendar application.

40. The system of claim 38, wherein a scheduling system performs the identifying.

41. The system of claim 37, wherein a scheduling system performs the changing.

42. The system of claim 37, wherein the events include a meeting.

43. The system of claim 38, wherein the visual identifier includes a color.

44. The system of claim 39, further comprising creating the temporary time zone in the calendar application for booking meetings in multiple time zones within a single calendar.

45. The system of claim 38, wherein the visual identifier distinguishes the temporary time zone within a calendar application using a color.

46. The system of claim 42, further comprising predicting the temporary time zone based on a location field of the meeting including an address.

47. The system of claim 46, further comprising parsing the address into a standard format.

48. The system of claim 37, further comprising automatically offering the user an opportunity to create the temporary time zone.

49. The system of claim 48, further comprising automatically offering the user the opportunity to create the temporary time zone, when the user books a flight to a location in a different time zone.

50. The system of claim 42, further comprising prompting the user to select from a plurality of choices for destination of the meeting to establish the temporary time zone.

51. The system of claim 50, wherein the destination includes one of a home address of an invitee to the meeting, a work address of an invitee to the meeting, a hotel address of an invitee to the meeting, a destination airport of an invitee to the meeting, and an address of a nearest meeting.

52. The system of claim 37, wherein a time of an individual event appears differently in different people's calendar, based on the temporary time zone.

53. The system of claim 42, further comprising booking the meeting using a new event dialog box.

54. The system of claim 53, wherein the visual identifier includes at least one of text, and a graphic indicator.
